(19) United States
(12) Patent Application Publication
(10) Pub. No.: US 2010/0194727 A1
(43) Pub. Date: Aug. 5, 2010

(54) PLASMA DISPLAY DEVICE

(76) Inventors: Yoshiho Seo, Yokohama (JP); Keiichi Betsui, Yokohama (JP); Tadayoshi Kosaka, Yokohama (JP)

Correspondence Address: MILES & STOCKBRIDGE PC, 1751 PINNACLE DRIVE, SUITE 500, MCLEAN, VA, 22102-3833, US

(21) Appl. No.: 12/676,603

(22) PCT Filed: Dec. 11, 2007
(86) PCT No.: PCT/JP2007/073882

§ 371 Date: Apr. 2, 2010

(51) Int. Cl. G06F 3/038

(52) U.S. Cl. 345/208; 345/60

(57) ABSTRACT

In a plasma display device, a temperature-monitoring electrode for monitoring a panel temperature is parallely arranged with at least either one of a display electrode and a scan electrode, or an address electrode in a PDP. And, a resistance-value monitoring circuit for monitoring a resistance value of the temperature-monitoring electrode is connected to the temperature-monitoring electrode, and further, a temperature-converting circuit for converting the resistance value monitored by the resistance-value monitoring circuit into a temperature is connected to the resistance-value monitoring circuit. And, respective driver drives respective electrode with applying a driving waveform and/or a driving voltage suitable for the temperature converted by the temperature-converting circuit, so that a useless margin design is unnecessary, and as a result, a performance in a normal-use situation can be improved.

### TECHNICAL FIELD

The present invention relates to a plasma display device, and more particularly, it relates to a technique effectively applied to a temperature-monitoring technique of a plasma display panel (hereinafter, referred to as PDP).

### BACKGROUND ART

According to a study by the present inventors, a PDP has a characteristic change due to a panel temperature change. More particularly, a discharge delay that is a time from voltage application until discharge generation is greatly affected by the panel temperature. More specifically, at low temperature, the discharge delay becomes large. Therefore, the panel temperature is monitored, and a driving waveform and/or voltage are changed in accordance with the panel temperature.

### DISCLOSURE OF THE INVENTION

### Problems to be Solved by the Invention

Incidentally, as a result of the study on the panel temperature-monitoring technique as described above by the present inventors, the following has been clarified.

For example, the panel temperature-monitoring technique is used not on a front surface of a panel but a rear surface of the same, and further, a monitorable area is limited, and therefore, a difference between the actual panel temperature and the monitor temperature is likely to occur. Therefore, a wide margin for the driving waveform and/or the voltage setting of the PDP needs to be secured against the temperature of the PDP. More particularly, a temperature variation of a discharge delay in an address period is large, and therefore, a design having a considerable margin as compared upon a normal-temperature time is needed in the address period. Therefore, there is a problem that a ratio of a display period which is a period of actually brightening a screen is reduced, resulting in darkening the screen.

Accordingly, a preferred aim of the present invention is to solve the problem as described above so that a useless margin design is unnecessary, and as a result, to provide a plasma display device whose performance can be improved in a normal-use situation.

The above and other preferred aims and novel characteristics of the present invention will be apparent from the description of the present specification and the accompanying drawings.

### Means for Solving the Problems

An outline of the typical ones of the inventions disclosed in the present application will be briefly described as follows.

That is, the outline of the typical ones is that, in a PDP, temperature-monitoring electrodes for monitoring the panel temperature are parallely arranged with at least either one of display and scan electrodes or an address electrode. And, a resistance-value monitoring circuit for monitoring a resistance value of the temperature-monitoring electrode is connected with the temperature-monitoring electrode, and further, a temperature-converting circuit for converting the resistance value monitored by the resistance-value monitoring circuit into a temperature is connected with the resistance-value monitoring circuit. And, a driver applies a driving waveform and/or a driving voltage suitable for the temperature converted by the temperature-converting circuit to drive each electrode. Alternatively, instead of newly arranging the temperature-monitoring electrode, at least either one of the display and scan electrodes or the address electrode is also used as the temperature-monitoring electrode.

### EFFECTS OF THE INVENTION

The effects obtained by typical aspects of the present invention will be briefly described below.

That is, as the effects obtained by typical aspects, a useless margin design is unnecessary, and as a result, a performance in a normal-use situation can be improved.

### BRIEF DESCRIPTIONS OF THE DRAWINGS

FIG. 1 is a view illustrating a configuration of a panel and drivers of a plasma display device according to a first embodiment of the present invention;

FIG. 2 is a diagram illustrating an equivalent circuit of a temperature-monitoring electrode and a resistance-value monitoring circuit in the first embodiment of the present invention;

FIG. 3 is a diagram illustrating a relation between a resistance value of the temperature-monitoring electrode and a monitored voltage in the first embodiment of the present invention;

FIG. 4 is a diagram illustrating a relation between the resistance value of the temperature-monitoring electrode and a monitored temperature in the first embodiment of the present invention;

FIG. 5 is a view illustrating a configuration of a panel and drivers of a plasma display device according to a second embodiment of the present invention;

FIG. 6 is a diagram illustrating driving waveforms in the second embodiment of the present invention;

FIG. 7 is a view illustrating a configuration of a panel and drivers of a plasma display device according to a third embodiment of the present invention;

FIG. 8 is a view illustrating a configuration of a panel and drivers of a plasma display device of a modification example in the third embodiment of the present invention; and

FIG. 9 is a view illustrating a configuration of a panel and drivers of a plasma display device according to a fourth embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

[Outline of Embodiment]

According to an embodiment of the present invention, a panel temperature can be accurately obtained by monitoring a resistance change of an electrode arranged on a panel, so that a suitable driving waveform and/or driving voltage are set in accordance with the temperature. For example, when an electrode mainly made of copper (Cu) is used, a temperature coefficient is about 0.0044/° C. Therefore, if a resistance-value change of, for example, about 0.5% can be monitored, the temperature can be monitored by an accuracy of 1° C.

Based on the outline of the present embodiment as described above, hereinafter, a basic configuration, a basic operation, and each embodiment of a plasma display device will be specifically described.

[Basic Configuration and Basic Operation of Plasma Display Device]

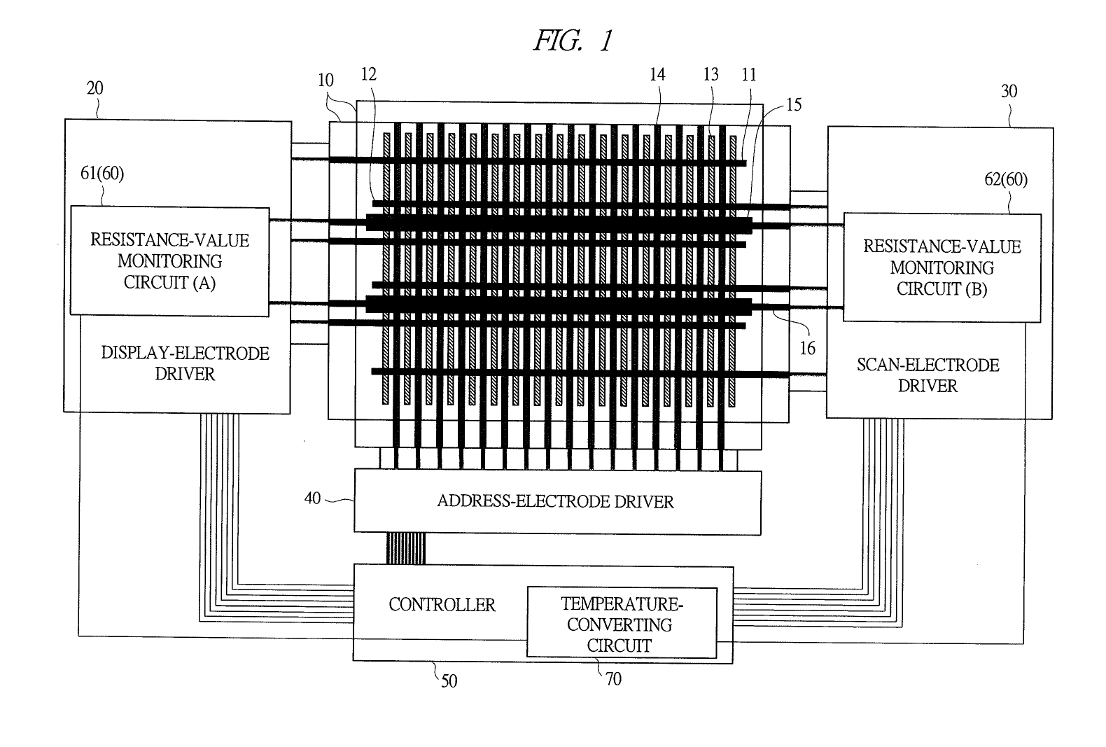

A plasma display device according to an embodiment of the present invention which is described with reference to FIG. 1 and others to be described later (a symbol for a corresponding principal unit is added in a parenthesis) includes: a PDP (10) having a plurality of display electrodes (11) and scan electrodes (12) parallely arranged with each other and a plurality of address electrodes (13) arranged so as to cross these display electrodes and scan electrodes; drivers (a display-electrode driver (20), a scan-electrode driver (30), and an address-electrode driver (40)) for driving each electrode of this PDP; a control circuit (controller (50)) for controlling these drivers; and others. Although details will be described later, a feature of the present embodiment is particularly that a temperature-monitoring electrode (16) for monitoring the temperature of the PDP is parallely arranged with at least either one of the display (11) and scan (12) electrodes or the address electrode (13). Alternately, instead of newly arranging the temperature-monitoring electrode, at least either one of the display and scan electrodes or the address electrode is also used as the temperature-monitoring electrode.

The PDP (10) is configured by combining a front-plate structure and a rear-plate structure and assembling the front-plate structure and the rear-plate structure so as to face each other. In the front-plate structure, the display electrodes and the scan electrodes are arranged on a glass plate. The display electrodes and the scan electrodes are covered by a dielectric layer and a protective film. In the rear-plate structure, the address electrodes are arranged on a glass plate so as to cross the display electrodes and the scan electrodes. The address electrodes are covered by a dielectric layer. A display cell generating discharge emission by these display electrodes, scan electrodes, and address electrodes is formed in a region crossing the address electrode within a region sandwiched by the display electrode and the scan electrode. Further, a black belt for contrast improvement is formed between the display cells in the front-plate structure.

A plurality of ribs for forming regions partitioned in, for example, a longitudinal stripe are formed between the front-plate structure and the rear-plate structure. In the respective regions partitioned by these ribs, a phosphor of respective colors of R (red), G (green), and B (blue) is coated. A pixel is composed of a display cell of these respective colors. Note that a structure in which ribs are provided in also a lateral direction is also possible. The front-plate structure and the rear-plate structure are assembled such that the protective film in the front-plate structure and the ribs in the rear-plate structure are contacted with each other. In an inner space between the front-plate structure and the rear-plate structure, a discharge space is formed by airtightly filling a discharge gas of, for example, Ne—Xe.

In the PDP configured as described above, each of the display electrodes, the scan electrodes, and the address electrodes is formed by stacking, for example, a transparent electrode made of ITO and a bus electrode made of Cr/Cu/Cr with using, for example, a screen printing method, a photolithography+etching method, or others. The dielectric layer is formed by coating, for example, a low-melting-point glass paste with using a screen printing method, or others and annealing the paste. The protective film is formed of, for example, an MgO film with using a vapor-deposition method, a sputtering method, a coating method, or others. The black belt is formed of, for example, a black paste containing Cu or others with using a screen printing method, a photolithography+etching method, or others. The rib is, for example, formed of a layer in which a material such as a low-melting-point glass paste is stacked, and formed by patterning the layer with using a sandblast method or others and annealing the layer. The phosphor is formed by, for example, coating a phosphor paste for each R, G, and B onto a region between the ribs with using a screen printing method, a dispenser method, or others and annealing the phosphor paste.

The display-electrode driver (20) is a circuit that is connected to electrode groups composed of the plurality of display electrodes in the PDP by using flexible cables and drives the electrode groups by commonly applying a driving waveform and/or a driving voltage to the electrode groups. The scan-electrode driver (30) is a circuit that is connected to electrode groups composed of the plurality of scan electrodes in the PDP by using flexible cables and drives the electrode groups by commonly applying a driving waveform and/or a driving voltage to the electrode groups in a reset period and a sustain period. The address-electrode driver (40) is a circuit that is connected to electrode groups composed of the plurality of address electrodes in the PDP by using flexible cables and drives the electrode groups by synchronously applying a driving waveform and/or a driving voltage with scan pulses to each of the electrode groups in an address period. The controller (50) is connected to each of the display-electrode driver, the scan-electrode driver, and the address-electrode driver in order to control each of these drivers. Although details will be described later, a feature of the present embodiment is particularly that a resistance-value monitoring circuit (60) for monitoring a resistance value of a temperature-monitoring electrode is arranged on any one of the display-electrode driver, the scan-electrode driver, and the address-electrode driver, and that a temperature-converting circuit (70) for converting the resistance value monitored by the resistance-value monitoring circuit into a temperature is arranged on the controller.

In a driving sequence for displaying, for example, a picture of one image (one field) in a plasma display device according to the present embodiment, the one field is composed of a plurality of sub fields. Each sub field includes the reset period, the address period, and the sustain period. Charges in the cell are controlled in the reset period in order to support a discharge in the subsequent address period, and the discharge for determining a cell in which light is emitted is performed in the address period. The discharge is repeatedly performed in the subsequent sustain period to cause the light emission in the cell. In this manner, the plasma display device is driven.

### First Embodiment

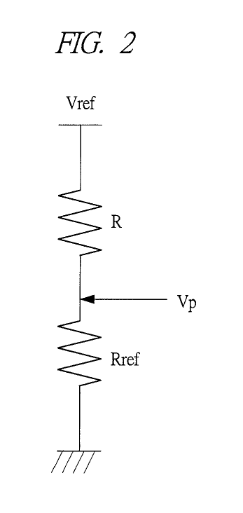

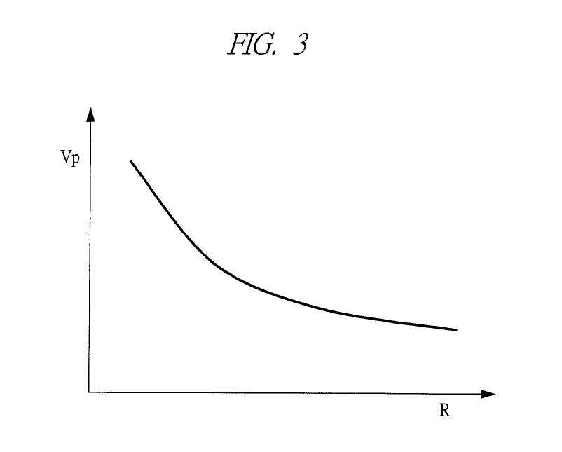

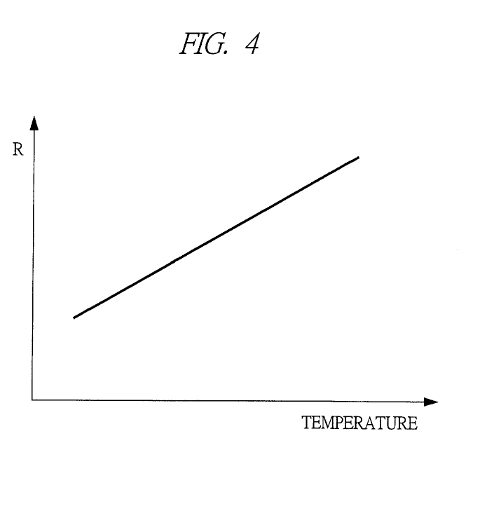

A first embodiment of the present invention is described with reference to FIGS. 1 to 4. FIG. 1 is a view illustrating a configuration of a panel and drivers of a plasma display device. FIGS. 2 to 4 illustrate a mechanism for monitoring a panel temperature with using a temperature-monitoring electrode, FIG. 2 is a diagram illustrating an equivalent circuit of the temperature-monitoring electrode and a resistance-value monitoring circuit, FIG. 3 is a diagram illustrating a relation between a resistance value of the temperature-monitoring electrode and a monitored voltage, and FIG. 4 is a diagram illustrating a relation between the resistance value of the temperature-monitoring electrode and a monitored temperature.

In the plasma display device according to the present embodiment, a temperature-monitoring electrode 16 for monitoring the panel temperature is parallely arranged with a display electrode 11 and a scan electrode 12 in a PDP 10. And, a resistance-value monitoring circuit 60 for monitoring a resistance value of the temperature-monitoring electrode 16 is arranged on a display-electrode driver (display-electrode driving circuit) 20 and a scan-electrode driver (scan-electrode driving circuit) 30 for driving the display electrode 11 and the scan electrode 12, respectively, and further, a temperature-converting circuit 70 for converting the resistance value monitored by the resistance-value monitoring circuit 60 into a temperature is arranged on a controller for controlling the display-electrode driver 20 and the scan-electrode driver 30. And, by the control of the controller 50, respective driver drives respective electrode with applying a driving waveform or a driving voltage, or both of them, which are suitable for the temperature converted by the temperature-converting circuit 70.

That is, as illustrated in FIG. 1, in the plasma display device according to the present embodiment, two temperature-monitoring electrodes 16 are parallely arranged with the display electrode 11 and the scan electrode 12 between the display cells. This temperature-monitoring electrode 16 is formed of, for example, a material such as Cr/Cu/Cr with using a screen printing method, a photolithography+etching method, or others similarly to a bus electrode of the display electrode 11 and the scan electrode 12. A position for arranging this temperature-monitoring electrode 16 is provided so as to overlap with, for example, a black belt 15 provided for improving a contrast.

The temperature-monitoring electrode 16 is connected to a resistance-value monitoring circuit 60 arranged on each of the display-electrode driver 20 and the scan-electrode driver 30. This resistance-value monitoring circuit 60 is configured such as a circuit to which a fall-of-potential method or a bridge method is totally employed. For example, when the fall-of-potential method as the simplest configuration is described, a resistance-value monitoring circuit (A) 61 is arranged on the scan-electrode driver 20, and a resistance-value monitoring circuit (B) 62 is arranged on the scan-electrode driver 30. Although a specific configuration will be described later in FIG. 2, the resistance-value monitoring circuit (A) 61 is a power source, and the resistance-value monitoring circuit (B) 62 is configured with a current-limiting resistor and a voltage-monitoring circuit.

Further, outputs from the resistance-value monitoring circuits (A) 61 and (B) 62 are connected to the temperature-converting circuit 70 arranged on the controller 50, and measurement values of the resistance-value monitoring circuits (A) 61 and (B) 62 are converted into a panel temperature by the temperature-converting circuit 70. And, based on the panel temperature converted by the temperature-converting circuit 70, a suitable driving waveform and/or driving voltage are adjusted by the controller 50.

Next, a mechanism of monitoring the panel temperature with using the temperature-monitoring electrode will be described with reference to FIGS. 2 to 4.

As illustrated in FIG. 2, a equivalent circuit of the temperature-monitoring electrode 16 and the resistance-value monitoring circuits (A) 61 and (B) 62 is composed of: a temperature-monitoring resistor R corresponding to a resistance component of the temperature-monitoring electrode 16 connected to a high potential side Vref of the power source and a ground potential side; and a reference resistor Rref. In this configuration, the high potential side Vref of the power source and the ground potential side are arranged to the resistance-value monitoring circuit (A) 61, and the reference resistor Rref is arranged to the resistance-value monitoring circuit (B) 62. And, the high potential side Vref of the resistance-value monitoring circuit (A) 61 is connected to one end of the reference resistor Rref of the resistance-value monitoring circuit (B) via the temperature-monitoring electrode 16 on one side, and the other end of the reference resistance Rref is connected to the ground potential side of the resistance-value monitoring circuit (A) 61 via the other temperature-monitoring electrode 16.

In this equivalent circuit, a voltage Vp at a connecting point between the temperature-monitoring resistor R (this resistance value is also defined as R) and the reference resistor Rref (this resistance value is also defined as Rref) can be represented by an expression of Rref×Vref/(R+Rref).

This voltage Vp is monitored by the voltage monitoring circuit of the resistance-value monitoring circuit (B) 62, and a resistance value R of the temperature-monitoring electrode 16 is obtained from the monitored voltage Vp based on a relation between the resistance value R of the temperature-monitoring electrode 16 and the monitored voltage Vp illustrated in FIG. 3. Further, by the temperature-converting circuit 70, a monitored temperature of the panel is obtained from the resistance value R of the temperature-monitoring electrode 16 based on a relation between the resistance value R of the temperature-monitoring electrode 16 and the monitored temperature illustrated in FIG. 4. In this manner, the panel temperature can be monitored by using the temperature-monitoring electrode 16.

As described above, according to the present embodiment, the temperature-monitoring electrode 16 is arranged on the PDP 10 and the resistance-value monitoring circuit 60 and the temperature-converting circuit 70 are provided therein, so that a difference between the actual panel temperature and the monitored temperature becomes small, and therefore, it is unnecessary to secure a wide margin for the setting of the driving waveform and/or the driving voltage of the PDP 10 with respect to the temperature of the PDP 10. More particularly, although temperature variation of the discharge delay in the address period is large, a design having the same margin as that at a normal temperature is possible in the address period. As a result, useless margin design is unnecessary and a performance in a normal-use situation can be improved.

Note that the example of newly arranging the temperature-monitoring electrode 16 such as the present embodiment is not limited to the case that the temperature-monitoring electrode 16 is provided so as to overlap with the black belt 15, and is considered as the following modification examples. (1) The temperature-monitoring electrode may come out from either one of the display-electrode driver or the scan-electrode driver, turn around to U-turn in the panel, and return to the same driver side. (2) The black belt may be made of the same material as that of the temperature-monitoring electrode. (3) The temperature-monitoring electrode may be provided among all the display lines. (4) The temperature-monitoring electrodes may be collectively connected to the resistance-value monitoring circuit. (5) The temperature-monitoring electrodes may be individually connected to the resistance-value monitoring circuit. (6) The temperature-monitoring electrodes may be not necessarily provided among all the display cells but thinned out in an appropriate interval. (7) When considering the connection to the circuit, it is also effective to provide the temperature-monitoring electrode, for example, at a seam portion of the flexible cable connecting between the driver circuit and the panel.

### Second Embodiment

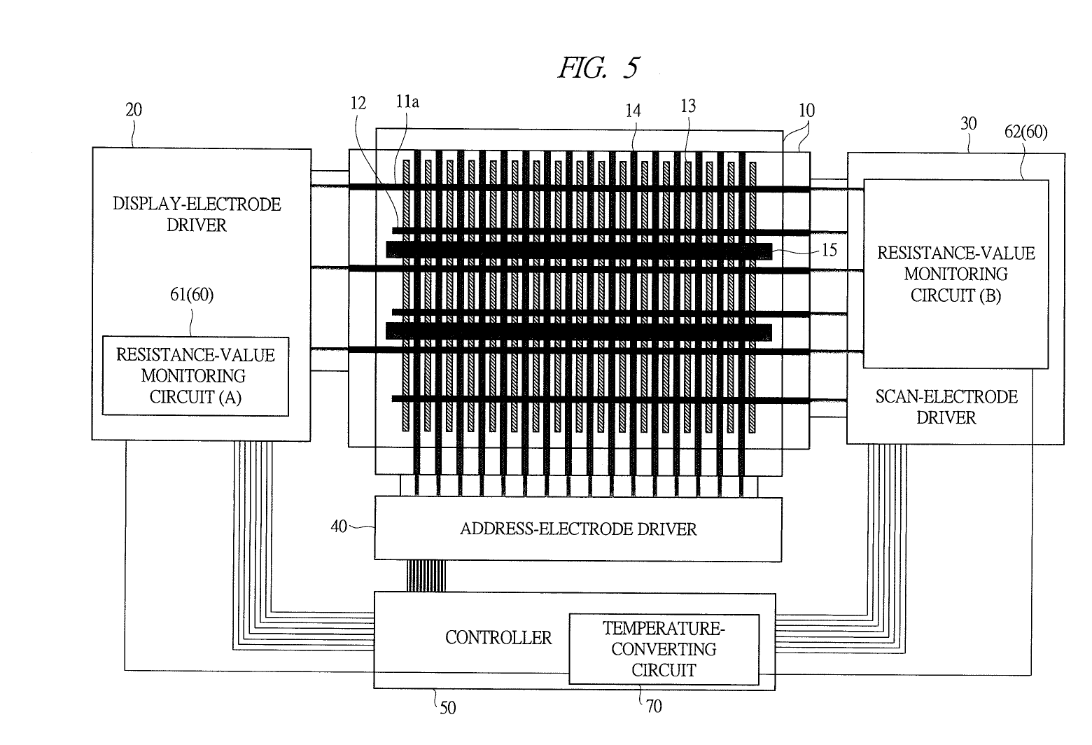

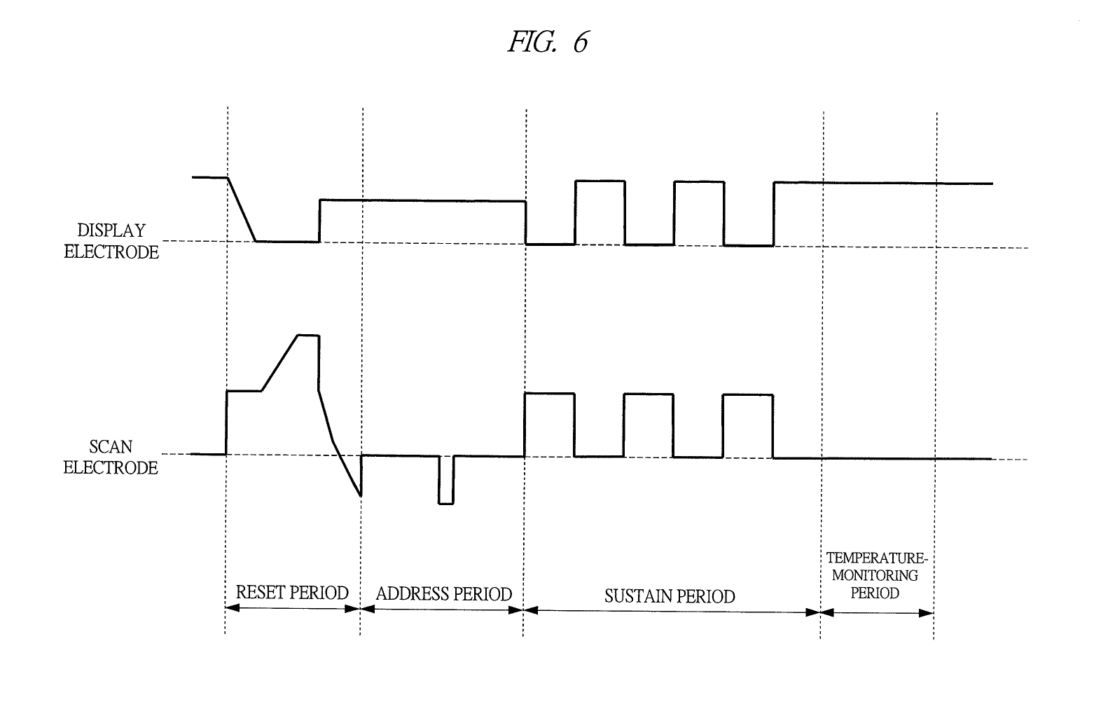

A second embodiment of the present invention is described with reference to FIGS. 5 and 6. FIG. 5 is a view illustrating a configuration of a panel and drivers of a plasma display device. FIG. 6 is a diagram illustrating waveforms.

The plasma display device according to the present embodiment is in an example of using a display electrode 11a and/or a scan electrode 12 also as the temperature-monitoring electrode instead of newly arranging the temperature-monitoring electrode in the PDP 10. And, the resistance-value monitoring circuits 60 for monitoring the resistance value of this temperature-monitoring electrode are arranged on the display-electrode driver 20 and the scan-electrode driver 30, and further, the temperature-converting circuit 70 for converting the resistance value monitored by this resistance-value monitoring circuits 60 into a temperature is arranged on the controller 50. And, by the control of the controller 50, respective driver drives respective electrode with applying a driving waveform or a driving voltage, or both of them which are suitable for the temperature converted by the temperature-converting circuit 70.

That is, as illustrated in FIG. 5, in the plasma display device according to the present embodiment, the display electrode 11a is also used as the temperature-monitoring electrode. And, a function for the resistance-value monitoring circuit (A) 61 is provided to a part of the display-electrode driver 20 for applying the driving voltage to the display electrode 11a also used as the temperature-monitoring electrode. Further, the other end of the display electrode 11a also used as the temperature-monitoring electrode is connected to the resistance-value monitoring circuit (B) 62 arranged on the scan-electrode driver 30 on the other side of the display-electrode driver 20. These resistance-value monitoring circuits (A) 61 and (B) 62 are configured such as a circuit to which a fall-of-potential method or a bridge method is employed similarly to the first embodiment.

Further, similarly to the first embodiment, outputs from the resistance-value monitoring circuits (A) 61 and (B) 62 are connected to the temperature-converting circuit 70 arranged on the controller 50, and measurement values of the resistance-value monitoring circuits (A) 61 and (B) 62 are converted into a panel temperature by the temperature-converting circuit 70. And, based on the panel temperature converted by the temperature-converting circuit 70, a suitable driving waveform and/or driving voltage are adjusted by the controller 50.

Next, drive waveforms in the case of using the display electrode also as the temperature-monitoring electrode is described with reference to FIG. 6.

As illustrated in FIG. 6, in a driving sequence, a temperature-monitoring period is provided after the usually necessary periods consisting of the reset period, the address period, and the sustain period for driving the display electrode 11a and/or the scan electrode 12, and the panel temperature is monitored with using the display electrode 11a also used as the temperature-monitoring electrode in this temperature-monitoring period.

As described above, according to the present embodiment, the display electrode 11a is also used as the temperature-monitoring electrode, so that the useless margin design is unnecessary and a performance in a normal-use situation can be improved similarly to the first embodiment, and further, since the temperature-monitoring electrode is not necessarily newly provided, the PDP 10 can be easily manufactured.

Note that, in the example of using the display electrode 11a also as the temperature-monitoring electrode similarly to the present embodiment, the following modification examples are considered. (1) The scan electrode can be used also as the temperature-monitoring electrode. (2) The number of electrodes used for monitoring the temperature may be two similarly to the first embodiment, or may be one, or three or more. (3) The electrodes connected to the resistance-value monitoring circuit may be collected as long as the driving sequence is not interrupted. (4) A method may be used in which, a switch is provided between the resistance-value monitoring circuit and the temperature-monitoring electrode, and this switch is turned off in periods except for the temperature-monitoring period, so that the resistance-value monitoring circuit and the temperature-monitoring electrode are substantially isolated from each other.

### Third Embodiment

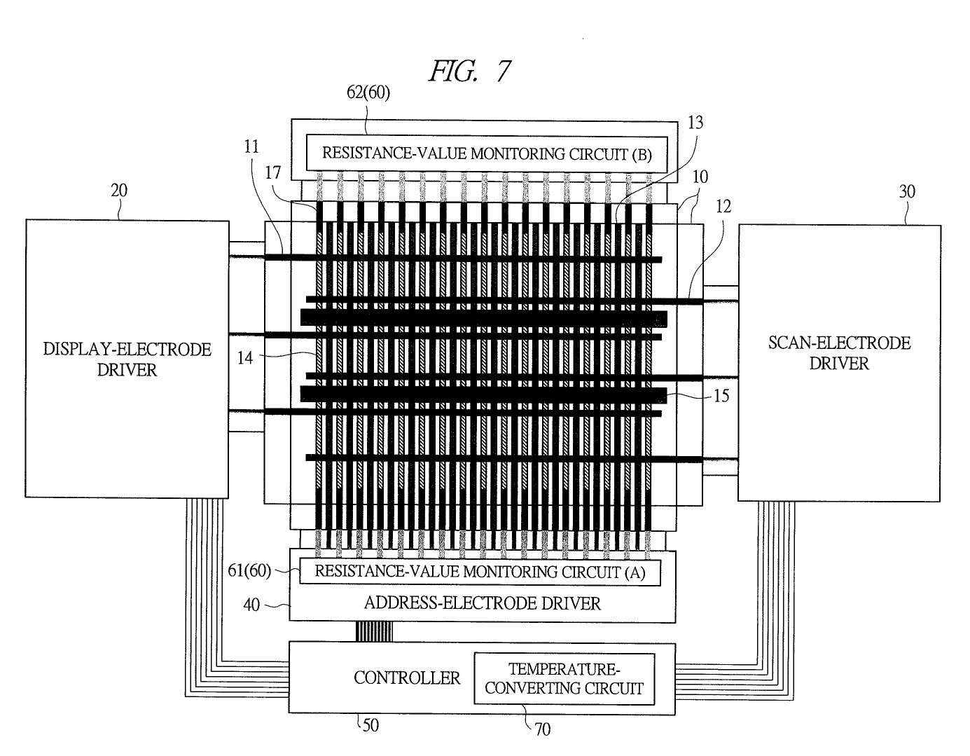

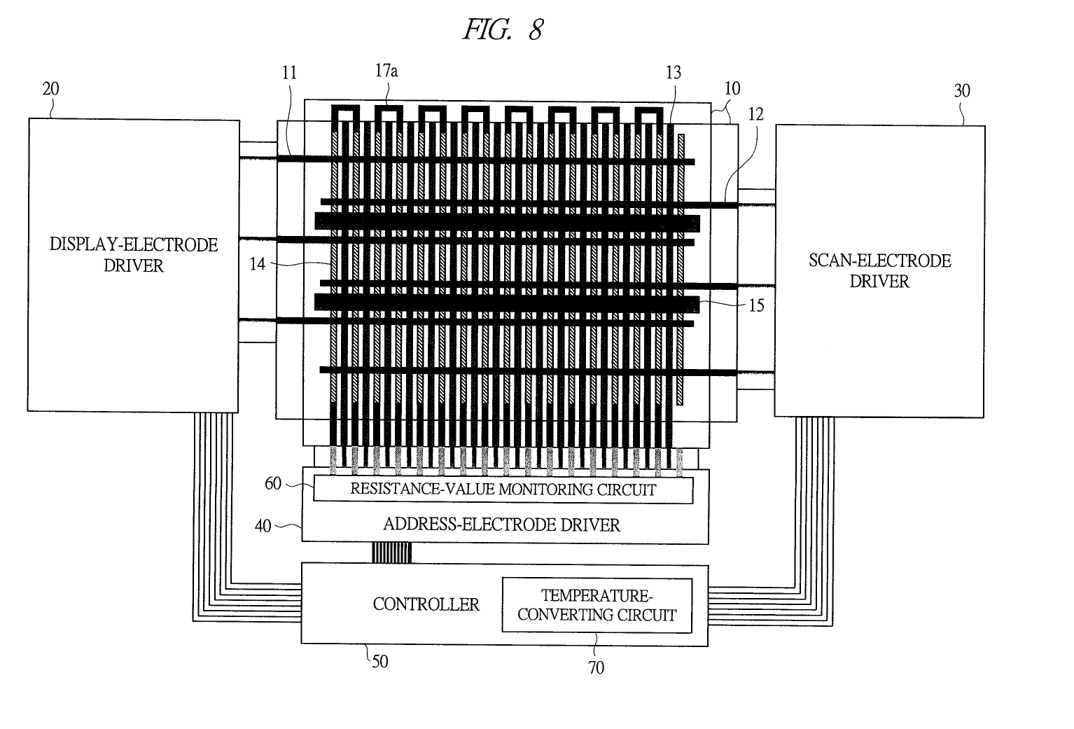

A third embodiment of the present invention is described with reference to FIGS. 7 and 8. FIG. 7 is a view illustrating a configuration of a panel and drivers of a plasma display device. FIG. 8 is a view illustrating a configuration of a panel and drivers of a plasma display device in a modification example.

The plasma display device according to the present embodiment is in an example of parallely arranging a temperature-monitoring electrode 17 with the address electrode 13 instead of parallely arranging the temperature-monitoring electrode with the display electrode 11 and the scan electrode 12 in the PDP 10. And, resistance-value monitoring circuits 60 for monitoring a resistance value of this temperature-monitoring electrode 17 are arranged on the address-electrode driver (address-electrode driving circuit) 40, and further, the temperature-converting circuit 70 for converting the resistance value monitored by this resistance-value monitoring circuits 60 into a temperature is arranged on the controller 50. And, by the control of the controller 50, respective driver drives respective electrode with applying a driving waveform or a driving voltage, or both of them which are suitable for the temperature converted by the temperature-converting circuit 70.

That is, as illustrated in FIG. 7, in the plasma display device according to the present embodiment, the temperature-monitoring electrode 17 is parallely arranged with the address electrode 13 between the address electrodes. This temperature-monitoring electrode 17 is formed of, for example, a material such as Cr/Cu/Cr with using a screen printing method, a photolithography+etching method, or others similarly to the address electrode 13. A position for arranging this temperature-monitoring electrode 17 is provided, for example, below a rib 14 provided for partitioning the discharge cell.

And, one end of the temperature-monitoring electrode 17 is connected to a resistance-value monitoring circuit (A) 61 arranged on the address-electrode driver 40 from the temperature-monitoring electrode 17, and the other end of the temperature-monitoring electrode 17 is connected to a resistance-value monitoring circuit (B) 62 arranged on the other side of the address-electrode driver 40. This resistance-value monitoring circuits (A) 61 and (B) 62 are configured such as a circuit to which a fall-of-potential method or a bridge method is employed similarly to the first embodiment.

Further, similarly to the first embodiment, outputs from the resistance-value monitoring circuits (A) 61 and (B) 62 are connected to the temperature-converting circuit 70 arranged on the controller 50, and measurement values of the resistance-value monitoring circuits (A) 61 and (B) 62 are converted into a panel temperature by the temperature-converting circuit 70. And, based on the panel temperature converted by the temperature-converting circuit 70, a suitable driving waveform and/or driving voltage are adjusted by the controller 50.

As described above, according to the present embodiment, the temperature-monitoring electrode 17 is parallely arranged with the address electrode 13, so that the useless margin design is unnecessary and a performance in a normal-use situation can be improved similarly to the first embodiment.

Note that, in the example of newly parallely arranging the temperature-monitoring electrode 17 with the address electrode 13 similarly to the present embodiment, the following modification examples are considered. (1) As illustrated in FIG. 8, the temperature-monitoring electrode 17a may start from the address-electrode driver 40, turn around to U-turn on the other side of this address-electrode driver 40, and return to this address-electrode driver 40 side. In this case, the resistance-value monitoring circuits 60 are unified on this address-electrode driver 40 side. (2) The temperature-monitoring electrodes may be collectively connected to the resistance-value monitoring circuit. (3) Temperature-monitoring electrodes may be individually connected to the resistance-value monitoring circuit. (4) The temperature-monitoring electrode may be not necessarily provided among all the address electrodes but thinned out in an appropriate interval.

### Fourth Embodiment

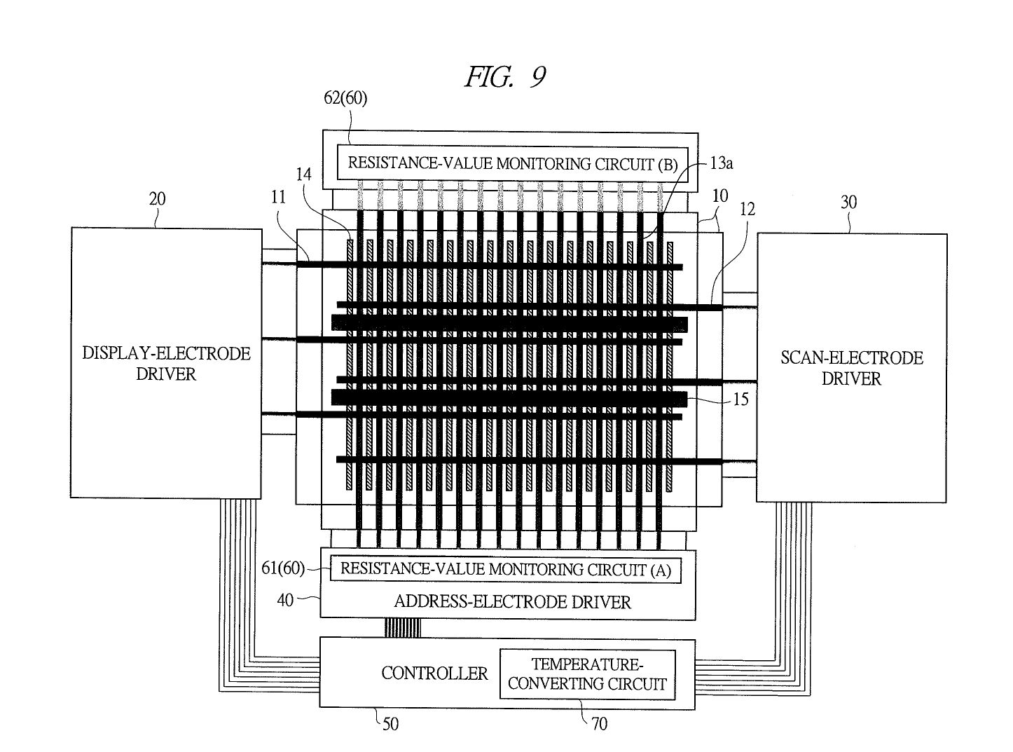

A fourth embodiment of the present invention is described with reference to FIG. 9. FIG. 9 is a view illustrating a configuration of a panel and drivers of a plasma display device.

The plasma display device according to the present embodiment is in an example of using an address electrode 13a also as the temperature-monitoring electrode instead of newly parallely arranging the temperature-monitoring electrode with the address electrode in the PDP 10. And, the resistance-value monitoring circuits 60 for monitoring the resistance value of this temperature-monitoring electrode are arranged on the address-electrode driver 40, and further, the temperature-converting circuit 70 for converting the resistance value monitored by this resistance-value monitoring circuits 60 into a temperature is arranged on the controller 50. And, by the control of the controller 50, respective driver drives respective electrode with applying a driving waveform or a driving voltage, or both of them which are suitable for the temperature converted by the temperature-converting circuit 70.

That is, as illustrated in FIG. 9, in the plasma display device according to the present embodiment, the address electrode 13a is also used as the temperature-monitoring electrode. And, a function for the resistance-value monitoring circuit (A) 61 is provided to a part of the address-electrode driver 40 for applying the driving voltage to the address electrode 13a also used as the temperature-monitoring electrode. Further, the other end of the address electrode 13a also used as the temperature-monitoring electrode is connected to the resistance-value monitoring circuit (B) 62 arranged on the other side of the address-electrode driver 40. These resistance-value monitoring circuits (A) 61 and (B) 62 are configured such as a circuit to which a fall-of-potential method or a bridge method is employed similarly to the first embodiment.

Further, similarly to the first embodiment, outputs from the resistance-value monitoring circuits (A) 61 and (B) 62 are connected to the temperature-converting circuit 70 arranged on the controller 50, and measurement values of the resistance-value monitoring circuits (A) 61 and (B) 62 are converted into a panel temperature by the temperature-converting circuit 70. And, based on the panel temperature converted by the temperature-converting circuit 70, a suitable driving waveform and/or driving voltage are adjusted by the controller 50.

As described above, according to the present embodiment, the address electrode 13a is also used as the temperature-monitoring electrode, so that the useless margin design is unnecessary and a performance in a normal-use situation can be improved similarly to the first embodiment, and further, since the temperature-monitoring electrode is not necessarily newly provided, the PDP 10 can be easily manufactured.

Note that, in the example of using the address electrode 13a also as the temperature-monitoring electrode similarly to the present embodiment, the following modification examples are considered. (1) The number of electrodes used for monitoring the temperature may be any number. (2) The electrodes connected to the resistance-value monitoring circuit may be collected as long as the driving sequence is not interrupted. (3) A method may be used in which, a switch is provided between the resistance-value monitoring circuit and the temperature-monitoring electrode, and this switch is turned off in periods except for the temperature-monitoring period, so that the resistance-value monitoring circuit and the temperature-monitoring electrode are substantially isolated from each other.

In the foregoing, the invention made by the inventors has been concretely described based on the embodiments. However, it is needless to say that the present invention is not limited to the foregoing embodiments and various modifications and alterations can be made within the scope of the present invention.

### INDUSTRIAL APPLICABILITY

The present invention is related to a plasma display device, and more particularly, the present invention can be used for a temperature-monitoring technique in a PDP.

What is claimed is:

1. A plasma display device comprising:
a plasma display panel having a plurality of display electrodes, a plurality of scan electrodes, and a plurality of address electrodes arranged so as to cross the display electrodes and the scan electrodes; and
a driver for driving each electrode of the plasma display panel, wherein
the plasma display panel includes
a temperature-monitoring electrode parallely arranged with at least either one of the display and scan electrodes or the address electrode for monitoring a temperature of the plasma display panel,
the plasma display device includes:
a resistance-value monitoring circuit connected to the temperature-monitoring electrode for monitoring a resistance value of the temperature-monitoring electrode; and
a temperature-converting circuit connected to the resistance-value monitoring circuit for converting the resistance value monitored by the resistance-value monitoring circuit into a temperature, and
the driver drives the each electrode with applying a driving waveform and/or a driving voltage suitable for the temperature converted by the temperature-converting circuit.

2. The plasma display device according to claim 1, wherein
the temperature-monitoring electrode is parallely arranged with the display electrode and the scan electrode,
the resistance-value monitoring circuit is arranged on a display-electrode driver and a scan-electrode driver for driving the display electrode and the scan electrode, respectively, and
the temperature-converting circuit is arranged on a controller for controlling the display-electrode driver and the scan-electrode driver.

3. The plasma display device according to claim 1, wherein
the temperature-monitoring electrode is parallely arranged with the address electrode,
the resistance-value monitoring circuit is arranged on an address-electrode driver for driving the address electrode, and
the temperature-converting circuit is arranged on a controller for controlling the address-electrode driver.

4. The plasma display device according to claim 1, wherein
the temperature-monitoring electrode is parallely arranged with the address electrode so as to be formed into a U-turn shape,
the resistance-value monitoring circuit is arranged on the address-electrode driver for driving the address electrode, and
the temperature-converting circuit is arranged in the controller for controlling the address-electrode driver.

5. A plasma display device comprising:
a plasma display panel having a plurality of display electrodes, a plurality of scan electrodes, and a plurality of address electrodes arranged so as to cross the display electrodes and the scan electrodes; and
a driver for driving each electrode of the plasma display panel, wherein
at least either one of the display and scan electrodes or the address electrode is also used as a temperature-monitoring electrode for monitoring a temperature of the plasma display panel,
the plasma display device includes:
a resistance-value monitoring circuit connected to the temperature-monitoring electrode for monitoring a resistance value of the temperature-monitoring electrode; and
a temperature-converting circuit connected to the resistance-value monitoring circuit for converting the resistance value monitored by the resistance-value monitoring circuit into a temperature, and
the driver drives the each electrode with applying a driving waveform and/or a driving voltage suitable for the temperature converted by the temperature-converting circuit.

6. The plasma display device according to claim 5, wherein
the resistance-value monitoring circuit is arranged on a display-electrode driver and a scan-electrode driver for driving the display electrode and the scan electrode, respectively, and
the temperature-converting circuit is arranged on a controller for controlling the display-electrode driver and the scan-electrode driver.

7. The plasma display device according to claim 5, wherein
the resistance-value monitoring circuit is arranged on an address-electrode driver for driving the address electrode, and
the temperature-converting circuit is arranged on a controller for controlling the address-electrode driver.
